(19) United States
(12) Patent Application Publication
(10) Pub. No.: US 2025/0119201 A1
(43) Pub. Date: Apr. 10, 2025

(54) RELAY DEVICE CONTROLLER, RELAY DEVICE CONTROL METHOD, RELAY DEVICE CONTROL PROGRAM, AND WIRELESS COMMUNICATION SYSTEM

(71) Applicant: NIPPON TELEGRAPH AND TELEPHONE CORPORATION, Tokyo (JP)

(72) Inventors: Riku OMIYA, Musashino-shi, Tokyo (JP); Tomoaki OGAWA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/730,339

(22) PCT Filed: Jan. 28, 2022
(86) PCT No.: PCT/JP2022/003381

§ 371 Date: Jul. 19, 2024

(51) Int. Cl. H04B 7/155

(52) U.S. Cl. CPC H04B 7/15528

(57) ABSTRACT

A relay device controller includes a reception station communication quality collection unit that collects information on communication quality of the reception station, a learning unit that acquires information collected by the reception station communication quality collection unit and calculates a control parameter of the relay device by reinforcement learning using a value based on the communication quality of the reception station as a reward, and a relay device control unit that controls the relay device with the control parameter calculated by the learning unit.

### TECHNICAL FIELD

The present disclosure relates to a relay device controller, a relay device control method, a relay device control program, and a wireless communication system.

### BACKGROUND ART

In order to handle mobile traffic that has increased in recent years, it is important to improve frequency utilization efficiency. Therefore, attempts have been made to improve signal strength and reduce interference by actively controlling the radio wave propagation environment itself. For example, Non Patent Literature 1 discloses a technology of varying a radio wave propagation environment by using a relay device such as a reflector in combination.

### CITATION LIST

### Non Patent Literature

Non Patent Literature 1: Riku Omiya and 5 other persons, “Interijentokukan keiseinotameno musenchukeiki kumiawase sentakuhou (in Japanese) (Repeater Selection Method for Intelligent Radio-space Design)”, Institute of Electronics, Information and Communication Engineers Society Convention, 2020

### SUMMARY

### Technical Problem

In the related art, it is difficult to dynamically control parameters such as an installation position and a reflection angle of a relay device necessary for creating a desired radio wave propagation environment, and it is difficult to improve communication quality in real time.

The present disclosure has been made in view of the above-described problem. An object of the present disclosure is to provide a relay device controller, a relay device control method, a relay device control program, and a wireless communication system capable of improving communication quality in real time.

### Solution to Problem

A relay device controller according to an aspect of the present disclosure is a relay device controller that controls a relay device that relays signals to be transmitted from a transmission station to a reception station. The relay device controller includes a reception station communication quality collection unit that collects information on communication quality of the reception station, a learning unit that acquires information collected by the reception station communication quality collection unit and calculates a control parameter of the relay device by reinforcement learning using a value based on the communication quality of the reception station as a reward, and a relay device control unit that controls the relay device with the control parameter calculated by the learning unit.

Each function of the relay device controller according to an aspect of the present disclosure can also be implemented as a wireless communication system.

In addition, a relay device control method according to an aspect of the present disclosure is a relay device control method of controlling a relay device that relays signals to be transmitted from a transmission station to a reception station. The relay device control method includes a reception station communication quality collection process of collecting information on communication quality of the reception station, a learning process of calculating a control parameter of the relay device by reinforcement learning using a value based on the communication quality of the reception station as a reward, and a relay device control process of controlling the relay device with the control parameter calculated in the learning process.

### Advantageous Effects

According to the present disclosure, it is possible to improve communication quality in real time.

### BRIEF DESCRIPTION OF DRAWINGS

FIG. 1 is a diagram schematically illustrating a configuration example of a wireless communication system according to a first embodiment.

FIG. 2 is a diagram illustrating an operation of each device constituting the wireless communication system according to the first embodiment.

FIG. 3 is a functional block diagram illustrating main functions of the relay device controller according to the first embodiment.

FIG. 4 is a flowchart illustrating an operation example of the relay device controller according to the first embodiment.

FIG. 5 is a functional block diagram illustrating a modification example of the relay device controller according to the first embodiment.

FIG. 6 is a flowchart illustrating a modification example of the relay device controller according to the first embodiment.

FIG. 7 is a diagram illustrating an example of a hardware configuration that implements each function of the wireless communication system and a relay device controller 4 according to the first embodiment.

### DESCRIPTION OF EMBODIMENTS

Hereinafter, embodiments will be described with reference to the accompanying drawings. In this disclosure, redundant description will be simplified or omitted as appropriate. Note that the present disclosure is not limited to the embodiments described below. The present disclosure may include various modifications and combinations of configurations disclosed in the following embodiment without departing from the spirit of the present disclosure.

### First Embodiment

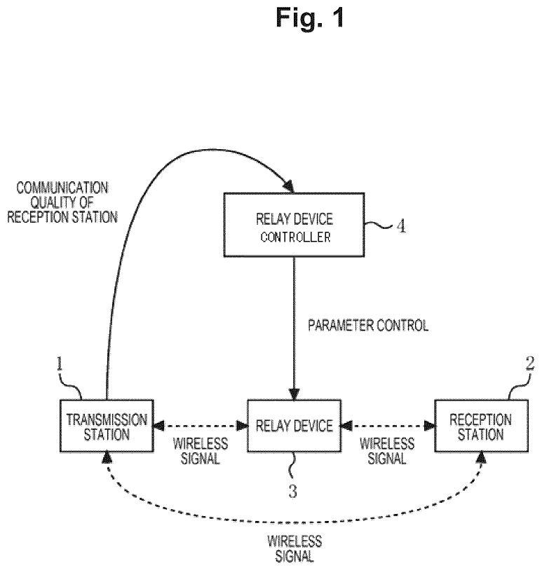

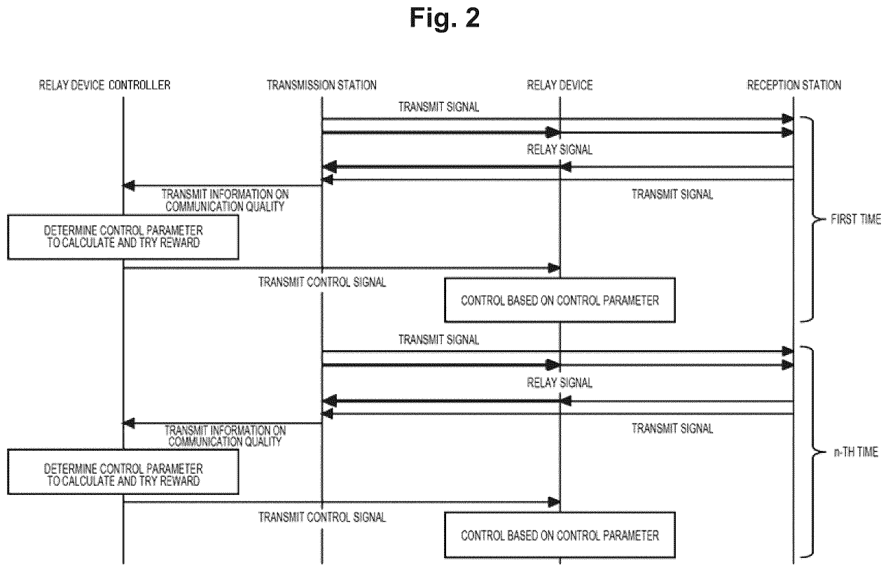

FIG. 1 is a diagram schematically illustrating a configuration example of a wireless communication system according to a first embodiment. FIG. 2 is a diagram illustrating an operation of each device constituting the wireless communication system according to the first embodiment.

The wireless communication system according to the present embodiment is a system that realizes a good radio wave propagation environment by relaying a signal transmitted from a transmission station 1 to a reception station 2 by a relay device 3. The relay device 3 corresponds to, for example, a reflector or the like that reflects and relays the radio waves transmitted by the transmission station 1. The wireless communication system may include a plurality of relay devices 3.

The relay device 3 is capable of controlling parameters such as an installation position and a reflection angle. By dynamically controlling each parameter of the relay device 3, for example, a good radio wave propagation environment can be secured in real time following environmental changes such as movement of an obstacle.

The wireless communication system according to the present embodiment includes a relay device controller 4. The relay device control apparatus 4 is an apparatus that controls the relay device 3. The relay device controller 4 has a function of dynamically calculating a parameter of the relay device 3 for creating a target radio wave propagation environment and controlling the relay device 3 with the calculated parameter.

As illustrated in FIG. 2, the transmission station 1 transmits a signal to the reception station 2. The reception station 2 transmits a signal to the transmission station 1 according to the received signal. The relay device 3 relays a signal transmitted from the transmission station 1 to the reception station 2 and a signal transmitted from the reception station 2 to the transmission station 1.

The signal transmitted from the reception station 2 to the transmission station 1 includes information on the communication quality of the reception station 2. The transmission station 1 transmits information on the communication quality of the reception station 2 included in the signal received from the reception station 2 to the relay device controller 4. Note that the relay device controller 4 may collect information on the communication quality of the reception station 2 from the reception station 2 or the relay device 3 without passing through the transmission station 1, for example.

The relay device controller 4 calculates a control parameter of the relay device 3 for realizing a target radio wave propagation environment by reinforcement learning using the communication quality of the reception station 2 as an input value. The relay device controller 4 uses the reinforcement learning algorithm to calculate a value based on the communication quality of the reception station 2 as a reward, and determines a control parameter to be tried by the relay device 3. Then, the relay device controller 4 transmits a control signal for attempting to control the relay device 3 with the determined control parameter to the relay device 3. The relay device 3 that has received the control signal is controlled based on the control parameter determined by the relay device controller 4.

As illustrated in FIG. 2, in the wireless communication system according to the present embodiment, determination of a control parameter by reinforcement learning, trial of control of the relay device 3 by the determined control parameter, and determination of a control parameter by reinforcement learning based on communication quality of the reception station 2 after the trial are repeated n times. As a result, the parameters of the relay device 3 are dynamically controlled, and the communication quality can be improved in real time. In addition, using reinforcement learning with the communication quality in real time as an input value, it is possible to reduce the labor of preliminary parameter examination in a stage before constructing the wireless communication system. For example, there is also a method of optically calculating a propagation direction in advance and setting a parameter, but in this method, only a direct wave can be considered due to a time constraint, and there is a problem that it is difficult to consider multipath. The present embodiment can also solve such a problem.

Examples of the communication quality include throughput, reception power, round trip time (RTT), channel state information (CSI), modulation and coding scheme (MCS), and the like. Note that not only the communication quality but also the reception station position information, the reception station moving direction/speed, the CSI acquired by another terminal near the reception station, the point cloud data around the transmission/reception station, and the like may be used as the input value of the reinforcement learning in the relay device controller 4.

As an example of calculation of a reward in reinforcement learning in the relay device controller, an example of calculation of a reward using an actual measured RTT, which is an example of communication quality, as a variable will be described. As an example, the reward is calculated according to Equation (1).

Reward={300 (RTT average value+RTT minimum value+RTT maximum value)}/30 Equation (1):

Here, the RTT average value, the RTT minimum value, and the RTT maximum value are values in the immediately preceding n seconds. Equation (1) above is obtained by normalizing the maximum value of the reward to 100 and the minimum value to 0 using the RTT average value (≤100), the RTT minimum value (≤100), and the RTT maximum value (≤ 100) in the immediately preceding n seconds as variables. Using the statistical value of the last n seconds instead of the instantaneous value of the RTT, it is possible to perform stable control while suppressing a change in reward with respect to a change in the RTT.

Note that Equation (1) above is merely an example. The calculation of the reward in the reinforcement learning may be performed such that the reward increases when the communication quality is good, such as a case where the RTT value is small, and the reward decreases when the communication quality is poor, such as a case where the RTT value is large.

In addition, the relay device 3 and the reception station 2 may not have one-to-one correspondence. One relay device 3 may relay a signal to a plurality of reception stations 2. In this case, information on the communication quality of the plurality of reception stations 2 is input to the relay device controller 4, and a parameter is calculated by reinforcement learning. For example, the population of the RTT average value, the RTT maximum value, and the RTT minimum value in Equation (1) is the communication quality in all the reception stations 2.

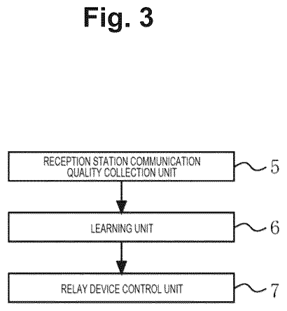

FIG. 3 is a functional block diagram illustrating main functions of the relay device controller 4 according to the first embodiment. The relay device controller according to the present embodiment includes a reception station communication quality collection unit 5, a learning unit 6, and a relay device control unit 7.

The reception station communication quality collection unit 5 collects information on the communication quality of the reception station 2. The learning unit 6 acquires the information collected by the reception station communication quality collection unit 5, and calculates the control parameter of the relay device 3 by reinforcement learning using a value based on the communication quality of the reception station 2 as a reward. The relay device control unit 7 controls the relay device 3 with the control parameters calculated by the learning unit 6.

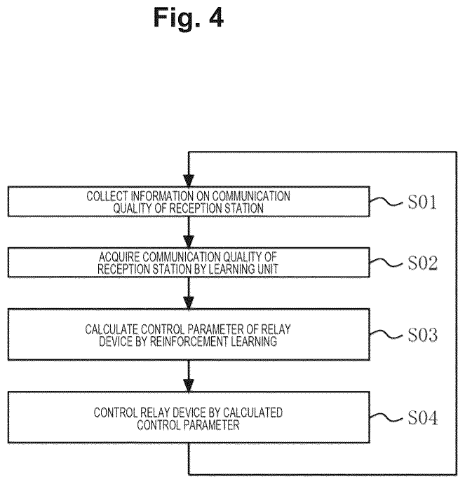

FIG. 4 is a flowchart illustrating an operation example of the relay device controller 4 according to the first embodiment. When communication is being performed in the transmission station 1, the reception station 2, and the relay device 3, the reception station communication quality collection unit 5 collects information on the communication quality of the reception station 2 (S01). Then, the learning unit 6 acquires the collected information on the communication quality of the reception station 2 (S02).

The learning unit 6 calculates a control parameter of the relay device 3 for realizing a target radio wave propagation environment by reinforcement learning using the acquired information on the communication quality as an input value (03). The relay device control unit 7 controls the relay device 3 with the control parameters calculated by the learning unit 6 (S04).

When communication is being performed in the transmission station 1, the reception station 2, and the relay device 3, Steps S01 to S04 are repeated. As a result, the relay device 3 is dynamically controlled, and the communication quality is improved in real time.

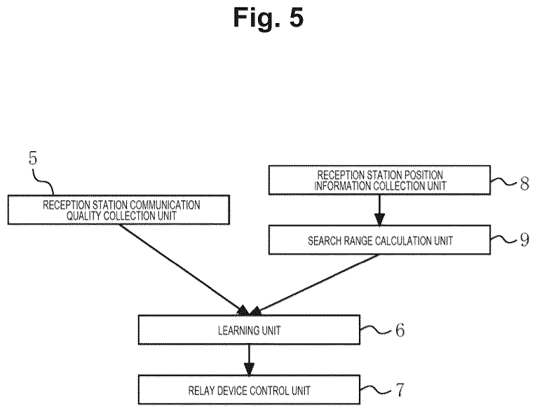

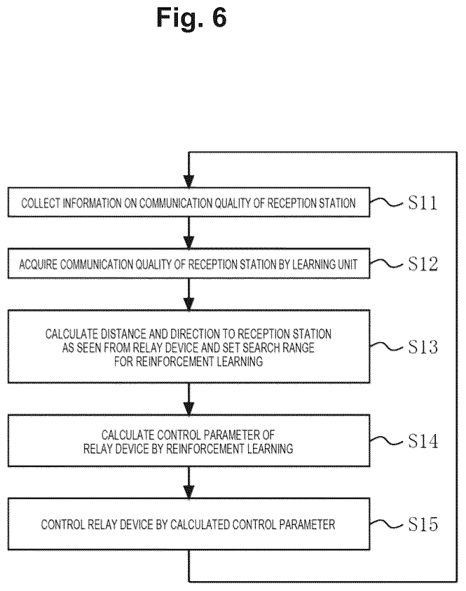

In addition, FIG. 5 is a functional block diagram illustrating a modification example of the relay device controller 4 according to the first embodiment. FIG. 6 is a flowchart illustrating a modification example of the relay device controller 4 according to the first embodiment.

The relay device controller 4 may include a reception station position information collection unit 8 that collects position information of the reception station 2 and a search range calculation unit 9 that sets a search range of reinforcement learning. Since Steps S11 and S12 in FIG. 6 are similar to Steps S01 and S02 in FIG. 4, the description thereof is omitted. In the present modification example, the search range calculation unit 9 calculates a distance and a direction to the reception station 2 as seen from the relay device 3 using the information collected by the reception station position information collection unit 8, and sets a search range for reinforcement learning in the learning unit 6 (S13). That is, the reception station position information collection unit 8 performs optical calculation based on the position information of the reception station 2 to narrow down a search range of reinforcement learning in the learning unit 6. The learning unit 6 calculates the control parameter of the relay device 3 in the narrowed search range (S14). The relay device control unit 7 controls the relay device 3 with the control parameters calculated by the learning unit 6 (S15). When communication is being performed in the transmission station 1, the reception station 2, and the relay device 3, Steps S11 to S15 are repeated. In the present modification example, the calculation result of the control parameter by the reinforcement learning can be made more appropriate according to the actual position of the reception station 2.

According to the wireless communication system and the relay device controller 4 configured as described above, it is possible to improve the communication quality in real time. The functions of the wireless communication system and the relay device controller 4 can also be implemented as a wireless communication method.

The wireless communication system according to the present embodiment can be realized as, for example, a single device such as the relay device controller 4, or can be realized by cooperation of a plurality of devices. Further, each function of the relay device controller 4 may be realized by cooperation of a plurality of devices.

Some or all of the functions of the wireless communication system and the relay device controller according to the above embodiment and modification example may be implemented using hardware such as an application specific integrated circuit (ASIC), a programmable logic device (PLD), or a field programmable gate array (FPGA). Each function of the wireless communication system may be implemented by a combination of dedicated hardware and software. In addition, some or all of the functions of the wireless communication system may be formed as a program executed by a processor such as a CPU. The program may be recorded in a computer-readable storage medium.

For example, the wireless communication system can be implemented by using a computer and a program, and the program can be recorded in a storage medium or provided through a network.

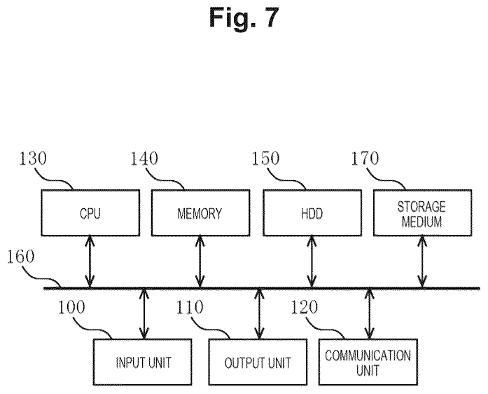

FIG. 7 is a diagram illustrating an example of a hardware configuration that implements each function of the wireless communication system and the relay device controller 4 according to the first embodiment. As illustrated in FIG. 7, the functions of the wireless communication system and the relay device controller 4 are implemented by, for example, an input unit 100, an output unit 110, a communication unit 120, a CPU 130, a memory 140, an HDD 150, and the like. The input unit 100, the output unit 110, the communication unit 120, the CPU 130, the memory 140, and the HDD 150 are connected via a bus 160 and have a function as a computer. In addition, the computer including the input unit 100, the output unit 110, the communication unit 120, the CPU 130, the memory 140, the HDD 150, and the like can input and output data to and from a computer-readable storage medium 170.

The input unit 100 is, for example, a keyboard, a mouse, or the like. The output unit 110 is, for example, a display device such as a display. The communication unit 120 is, for example, a wireless network interface.

The CPU 130 controls each unit constituting the wireless communication system and the relay device controller 4, and performs predetermined processing and the like. The memory 140 and the HDD 150 function as a storage unit that stores various data and the like.

The storage medium 170 stores a program for executing each function of the wireless communication system and the relay device controller 4. Note that the architecture constituting the wireless communication system and the relay device controller 4 is not limited to the example illustrated in FIG. 7.

The “computer” as used herein includes an OS and hardware such as peripheral devices. The “computer-readable storage medium” is, for example, a portable medium such as a flexible disk, a magneto-optical disc, a ROM, or a CD-ROM.

Furthermore, the “computer-readable storage medium” may be a medium that dynamically holds a program for a short period of time like a communication line in a case where the program is transmitted via a network such as the Internet or a communication line such as a telephone line. In addition, the “computer-readable storage medium” may be a medium that holds a program for a certain period of time, such as a volatile memory inside a computer serving as a server or a client.

### INDUSTRIAL APPLICABILITY

The relay device controller, the relay device control method, the relay device control program, and the wireless communication system according to the present disclosure can be applied to, for example, a mobile base station that provides wireless communication.

### REFERENCE SIGNS LIST

1 Transmission station
2 Reception station
3 Relay device
4 Relay device controller
5 Reception station communication quality collection unit
6 Learning unit
7 Relay device control unit
8 Reception station position information collection unit
9 Search range calculation unit
100 Input unit
110 Output unit
120 Communication unit
130 CPU
140 Memory
150 HDD
160 Bus
170 Storage medium

1. A relay device controller that controls a relay device that relays a signal transmitted from a transmission station to a reception station, the relay device controller comprising:
a reception station communication quality collection circuitry that collects information on communication quality of the reception station;
a learning circuitry that acquires information collected by the reception station communication quality collection circuitry and calculates a control parameter of the relay device by reinforcement learning using a value based on the communication quality of the reception station as a reward; and
a relay device control circuitry that controls the relay device with the control parameter calculated by the learning circuitry.

2. A relay device control method of controlling a relay device that relays a signal transmitted from a transmission station to a reception station, the relay device control method comprising:
collecting information on communication quality of the reception station;
calculating a control parameter of the relay device by reinforcement learning using a value based on the communication quality of the reception station as a reward; and
controlling the relay device with the control parameter calculated.

3. (canceled)

4. A wireless communication system that relays signals to be transmitted from a transmission station to a reception station by a relay device, the wireless communication system comprising:
a reception station communication quality collection circuitry that collects information on communication quality of the reception station;
a learning circuitry that acquires information collected by the reception station communication quality collection circuitry and calculates a control parameter of the relay device by reinforcement learning using a value based on the communication quality of the reception station as a reward; and
a relay device control circuitry that controls the relay device with the control parameter calculated by the learning circuitry.
